(19) United States
(12) Patent Application Publication
(10) Pub. No.: US 2003/0182391 A1
(43) Pub. Date: Sep. 25, 2003

(54) Internet based personal information manager

(76) Inventors: Mike Leber, Fremont, CA (US); Benny B. Ng, Dublin, CA (US)

Correspondence Address: NATH & ASSOCIATES PLLC, Sixth Floor, 1030 Fifteenth Street, N.W., Washington, DC, 20005, US

(21) Appl. No.: 10/100,080

(22) Filed: Mar. 19, 2002

(51) Int. Cl. G06F 15/16

(52) U.S. Cl. 709/217; 707/4

(57) ABSTRACT

A system and a method for providing a remotely accessible Personal Information Manager. The method involves using natural language sentences to send personal information and inquiries through an instant messaging agent, from a user's computer connected to an electronic communications network, to a chat-bot software application running on a remote computer. The chat-bot sends queries to and retrieves information from a database connected to the remote computer. The chat-bot builds a natural language sentence with an output from the database, and sends it back to the user's computer through the instant messaging agent.

### FIELD OF THE INVENTION

This invention relates to Internet based software applications and more particularly to an Internet based personal information manager.

### BACKGROUND OF THE INVENTION

The following terms are used in the present application with their following, current commonly accepted meaning.

A “chat-bot” application or sometimes more simply referred to as a “chat-bot” (contraction of “chatting robot”) is a computer program that provides a natural language interface between a user and a software application.

A “client”, in the context of the present invention, is a computer program that allows a user to communicate with a computer server and to use services provided by the computer server. Current examples of clients include Web browsers such as Netscape Navigator and Microsoft Internet Explorer.

A “computer apparatus” is a system that can process information or data and is to be taken very broadly to include a conventional personal computer, a mini computer, a mainframe computer, any microprocessor-driven device such as a hand held or Palm computer, and even a mobile telephone unit that incorporates information or data processing.

An “Instant Messaging agent” or IM agent is a computer program that allows two or more users to communicate in real time by sending and receiving written messages using an electronic communication device such as a computer, a Personal Digital Assistant (PDA) or a cellular telephone connected to a communications network. Current examples of instant messaging agents include: “AOL Instant Messenger”, “MSN Messenger”, “ICQ” and “Yahoo! Messenger”. The IM agent receives a user's input and when activated assembles an outbound message that contains a screen name of the user.

“Personal Information Managers” (PIM's), as a concept, have existed since the beginning of human history. Whether it be written on papyrus, stored in a person's memory or organized in a database, it is a collection of records that permit, management of appointments, of people's name and of contact information, and of reminders of things to do.

A “Personal Digital Assistant” (PDA), such as a PALM computing platform, is an electronic computer apparatus that combines all of the functions of a conventional “PIM” in a device that is small and light enough to fit inside a shirt pocket.

The “World Wide Web”, sometimes denoted “WWW” or more simply called the Web, is a sub-set of a world-wide network of computers known as the Internet. The Web is made of all publicly accessible electronic files or documents, also called Web pages, stored in computers connected to the Internet. These Web pages are uniquely identifiable by a Uniform Resource Locator (URL) which is a string of characters that describes the location, name and type of the Web page. Web pages can be grouped in Web sites which are sets of electronic files having a common purpose and that are usually located on a same computer server.

In recent years, with the advent of the Internet and the decreasing size of electronic devices, PIM systems have migrated from human and/or paper based supports, such as notebooks, to electronic supports such as personal desktop and laptop computers, remotely accessible Internet based servers, and pocket-size computers, such as Personal Digital Assistants.

Examples of these electronic prior art supports or systems are described in the following U.S. patents and U.S. patent application publications, of which the entire contents are herein incorporated by reference:

U.S. Pat. No. 6,278,993 to Kumar, U.S. Pat. No. 5,983,200 to Slotznick, U.S. Pat. No. 5,855,006 to Huemoeller, Applic. Pub. No. 2001/0047356 by Ren, Applic. Pub. No. 2001/0049617 by Berenson, Applic. Pub. No. 2001/0047290 by Petras, Applic. Pub. No. 2001/0049722 by Bush, and Applic. Pub. No. 2001/0014839 by Belanger.

The Kumar patent discloses an Internet software system which provides a user with greater depth for searching the Internet, and stores information related to the user.

The Slotznick patent discloses a database system which uses natural language commands for accomplishing tasks using several communication media, including the Internet. The system can share both its learned and preprogrammed databases with other software such as schedulers and contact managers.

The Huemoeller et al. patent discloses a software application for personal activity scheduling by means of a database on the user's computer. The database allows the user to access information via the Internet on a variety of subjects including travel information.

The Ren patent application describes a remotely accessible and maintained web based database. A described preferred embodiment relates to a web based customer list database. This system maintains the database by notifying customers of the current information that the database contains about them and recording their feedback.

The Berenson patent application discloses a web-driven calendar updating system which has a database accessible via the Internet, that allows the user to create calendar reminders for scheduled upcoming events. This system allows for updating of the calendar by the database if a change occurs in the schedule.

The Petras patent application describes a computer system, usable by a large population of Internet users, for creating and maintaining information in a searchable database of defined categories of subjects. The database utilizes natural language terms for assisting a particular user to base a subject search at least upon a chosen set of particular-user-preferred such natural language terms.

The Bush patent application discloses a method and apparatus for providing advice or services to a plurality of users. This web based system uses a database to direct the questions of users to a proper resource or expert.

The Belanger patent application describes a server-sided Internet based system in which users access the system through a web-site and can use applications such as a personal information manager, contact manager and financial management software.

All these prior art systems rely on a database, this database being either installed on the user's computer or accessed through a Web site.

The installation of the database on the user's computer also necessitates the installation of a database management software and having enough electronic storage space on the computer to store all the data. In the case of a Portable Digital Assistant, both the computing power to run the database management software and the storage space are limited. This limits the size and functionality of the database.

When the database is accessible through a Web site, the size and functionality of the database can be expanded dynamically according to the needs of the users, but accessing the data can become cumbersome. The user typically has to go through several Web pages before getting access to his/her own personal data. These Web pages are downloaded from a server at a speed that can vary greatly according to the communications network load and to the size of files being downloaded. The downloading speed will typically become very low if a large number of users are accessing the server at the same time and if the downloaded pages contain many picture files, which are larger than text files.

Thus, there is a need for a Personal Information Management system that combines the convenience, speed and ease of use of a PDA with the computing power and data capacity of a Web based or desktop computer based PIM system.

There is also a need for a system that allows the user to access a variety of functions using a single, fast, easy to use, powerful and widely accessible application.

### SUMMARY OF THE INVENTION

The present invention overcomes the deficiencies of the prior art by providing a chat-bot system that is remotely accessible through an instant messaging (IM) software application and a method of using that system and that instant messaging software application as a Personal Information Manager (PIM). The instant messaging software application provides an interface that is much faster than Web-based applications because it is a text-based application and text can be sent and received much faster than complex Web pages.

Another advantage of the present invention is the ability of the user to send natural language statements and queries for storing and retrieving information from a database. These statements and queries are parsed and interpreted by a chat-bot. The chat-bot receives a natural language question and converts it into a formal query that is sent to the database. The result of the query is then translated back into a natural language sentence that is sent to the user.

The present invention also provides a personal information management system that can be accessed from any location in the world having a connection to a communication network such as the Internet. Furthermore, when used in conjunction with a wireless communication device, the present invention brings the ease of use, power and speed, as previously described, to virtually any part of the world.

Additionally, the present invention eliminates the requirement for a user to carry a device containing their personal information such as a “PALM” computer. Such devices can be easily lost or stolen and the information can thereby be compromised. However, according to the present invention, all the information is stored on a server, not on the accessing device, and the server can be rapidly accessed remotely from virtually anywhere in the world through the communication network.

The foregoing and other advantages of the present invention are realized by a system that combines:

a computer apparatus connected to a communications network such as the Internet;

a chat-bot application installed on the computer apparatus;

a database stored on a computer storage medium and directly accessible by the chat-bot application; and

a communication software application such as an instant messaging agent operable over a communications network such as the Internet, that allows a user to establish a contact with the chatbot application and interact with the chat-bot the same way the user would interact with a human person using the instant messaging agent.

The present invention also embodies a method of maintaining a personal information manager that combines the steps of:

using a computer apparatus running an instant messaging agent and having access to an electronic communications network to communicate with a remote computer system running a chat-bot application;

sending a natural language sentence to the chat-bot through the instant messaging agent, this sentence containing a request to the chat-bot to retrieve information from a database or providing information to the chat-bot for storing this information in the database;

receiving a natural language response from the chat-bot through the instant messaging agent, this response being a construction by the chat-bot of a natural language sentence built using the information provided to the chat-bot in the request message, information provided by the database, and an appropriate predetermined template.

The present invention further embodies a method of providing a remotely accessible personal information manager that combines the steps of:

running an instant messaging agent on a computer connected to an electronic communications network and to a computer accessible database;

running a chat-bot application capable of using the instant messaging agent to send and receive messages from other computers connected to the network and running an instant messaging agent, this chat-bot being capable of sending queries to, and retrieving information from the database;

receiving a natural language message through the instant messaging agent from one of the other computers;

parsing the message to identify a user and extract a type and content of command contained in the message;

building a formal query using information extracted from the message;

sending this query to the database;

receiving an output from the database;

combining the output from the database with the content of the command and an appropriate predetermined template to build a natural language response;

sending the natural language response back to the computer of the identified user through the instant messaging agent.

### BRIEF DESCRIPTION OF THE DRAWINGS

FIG. 1 is a schematic diagram illustrating a system for Internet based information management according to the present invention.

FIG. 2 is a schematic flow diagram of a computer program illustrating a module that matches a user input with predetermined templates associated with executable modules according to the present invention.

FIG. 2a is a schematic flow diagram of a computer program illustrating a spell-checking module according to the present invention.

FIG. 2b is a schematic flow diagram of a computer program illustrating a process for building a response sentence according to the present invention.

FIG. 3 is a schematic flow diagram illustrating a set of functions accessible through an information management system according to the present invention.

FIG. 4 is a schematic flow diagram of a computer program illustrating the flow of information, and tests performed, in a personal information management system according to the present invention.

FIG. 5 is a schematic flow diagram of a computer program illustrating the flow of information, and tests performed, in an appointment manager according to the present invention.

FIG. 6 is a schematic flow diagram of a computer program illustrating the flow of information, and tests performed, in a reminder manager according to the present invention.

FIG. 7 is a schematic flow diagram of a computer program illustrating the flow of information, and tests performed, in a security control manager according to the present invention.

### DETAILED DESCRIPTION OF THE PREFERRED EMBODIMENT

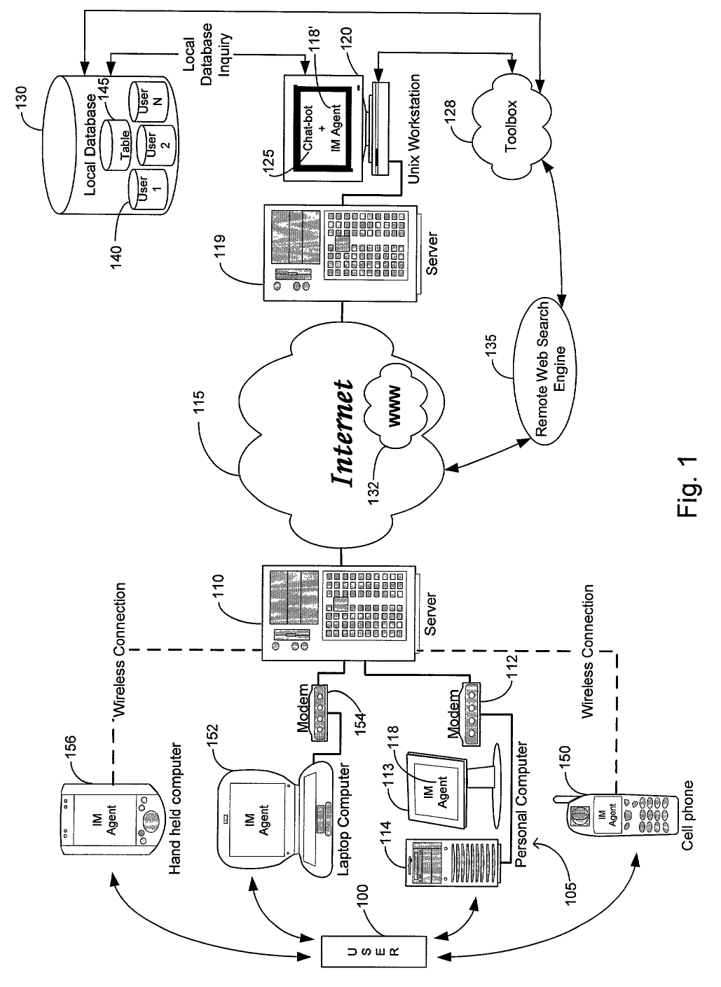

With reference now to the figures wherein like elements have the same number throughout the several views, and in particular with reference to FIG. 1, a communications system comprised of a combination of software applications, computers and communication networks according to a presently preferred embodiment of the present invention is depicted.

In a preferred embodiment of the invention a personal computer (PC) 105 is depicted as being used by a generic user 100, and is connected to a conventional server 110 through a conventional modem 112. Server 110 in turn is connected to a communications network 115, such as a global computer network like the Internet. Personal computer 105 is a conventional personal computer with a display 113 and a console 114 containing a Central Processing Unit (CPU), a Random-Access Memory (RAM) and a Hard Disk (HD) for permanent storage of computer programs and data (all not shown).

An instant messaging agent (IM) 118 is stored on the hard disk of personal computer 105 and is uploaded into the RAM where it is executed by the CPU. IM agent 118 uses a communications link between PC 105 and a remote computer 120, which is also connected to communications network 115 through a second communications server 119. Remote computer 120 is also connected to a local database 130 and through Internet 115 to a World Wide Web 132, which is depicted in FIG. 1 as being a subset of Internet 115.

In a presently preferred embodiment of the invention, remote computer 120 is a conventional UNIX workstation equipped with a Hard Disk, Random Access Memory and a Central Processing Unit (CPU) (all not shown). However, any server workstation, or even a minicomputer or mainframe computer could be used. Communications network 115 can also be a LAN, WAN, or another global communications network.

Remote computer 120 communicates with a plurality of personal computers 105 or other communication devices through an IM agent 118′ that is stored on its HD and loaded on its RAM for execution by its CPU. IM agent 118′ can be a computer program that is the same or substantially the same as IM agent 118 stored on personal computer 105 or is completely compatible therewith. Instead of being operated by a human operator, IM agent 118′ on remote computer 120 is operated by a chat-bot application 125, or simply chat-bot 125 as described in greater detail hereinbelow.

Remote computer 120 has stored on its hard disk a set of subroutines commonly called a toolbox and depicted at 128 in FIG. 1. The subroutines of toolbox 128 are called by chat-bot 125 and executed by the CPU of remote computer 120. Toolbox 128 comprises one or more subroutines that connect remote computer 120 to Internet 115 through a remote web search engine 135 and to a local user database 130. Local user database 130 can be part of the hard disk of remote computer 120 or a separate conventional memory storage device such as a tape drive or a disk drive. Local user database 130 is comprised of a plurality of virtual portions 140, each portion being assigned to represent a separate user. Local user database 130 also is comprised of a table 145 of all users 100 who have previously communicated with chat-bot 125. Remote computer 120 is also connected to other databases which contain elements of the system as described below, an example of one such component being a dictionary of correctly spelled words.

Chat-bot 125 receives and sends natural language messages from and to computer 105 used by user 100. Chat-bot 125 also interprets commands given by user 100 to launch a plurality of functions or tools indirectly made available to user 100 in toolbox 128. These functions store and retrieve electronic data from local database 130 and can also redirect queries to, and receive answers from remote web sites, accessible through Internet 115, by launching a remote web search. One of the plurality of functions available to the user is a Personal Information Manager (PIM) that stores and manages personal information pertaining to each user on separate portions 140 of database 130.

As shown in FIG. 1, a plurality of devices can use IM 118 instead of or in addition to computer 105. These devices include without limitations, a cell phone 150 remotely connected to server 110 or to Internet 115; a laptop computer 152 connected to Internet 115 through modem 154 and server 110 as shown, or directly to Internet 115 through only server 110; and a hand held computer 156, remotely connected to Internet 115 or through server 110. In FIG. 1, personal computer 105, cell phone 150, laptop computer 152 and hand held computer 156 also form a LAN (Local Area Network), but could all be separately connected either through Internet 115 or a direct connection to server 110.

In use, a message is sent through IM 118, from personal computer 105 used by user 100, through modem 112 and server 110 to remote computer 120, through Internet 115 and server 119 as shown in FIG. 1. A first word of the message is comprised of a string of characters that identifies user 100 with respect to IM agent 118, and is called a screen-name. The rest of the message contains, if desired, an encrypted password or other identifying and confirming information, appropriate headers and trailers, and a text portion.

As described hereinbelow, chat-bot 125 uses remote computer 120 to receive the text portion of the message and to parse it, word by word to determine the character and nature of the entire message. Once the character and nature of the message is determined, chat-bot 125, using the tools described hereinbelow in toolbox 128, connects remote computer 120 to the appropriate database to either answer an inquiry or store information in a user's PIM stored in the appropriate virtual portion 140 of a local database 130. Depending on the nature of the message, chat-bot 125 then assembles or composes an appropriate response. This response is then transmitted back to personal computer 105 by the same path the original message took, i.e. through server 119, through Internet 115, through server 110, through modem 112 to personal computer 105. Personal computer 105 then displays the response on monitor 113.

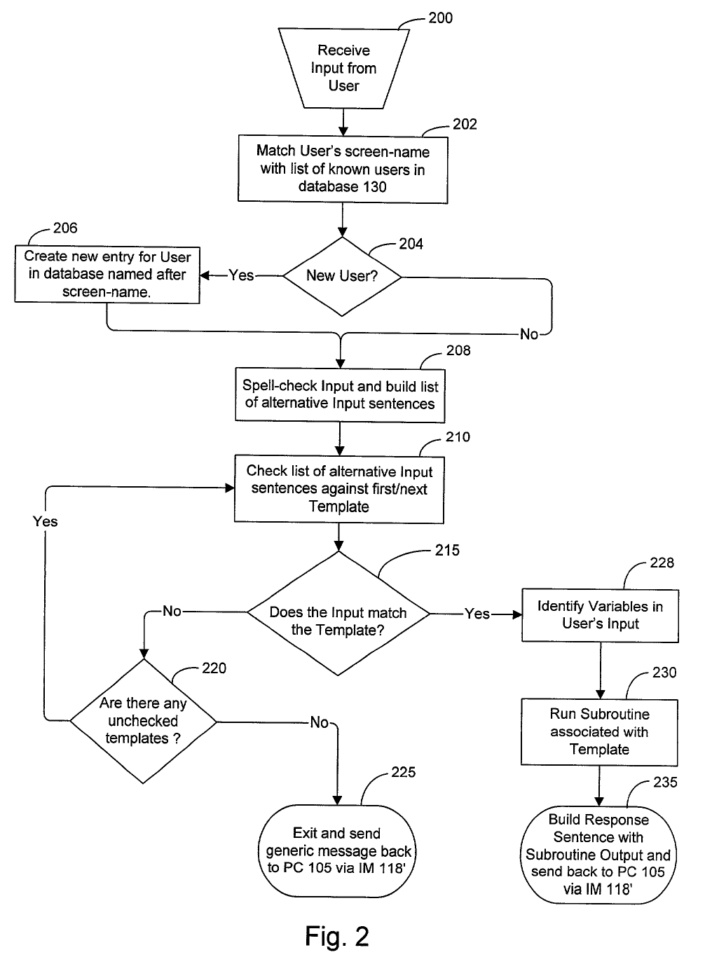

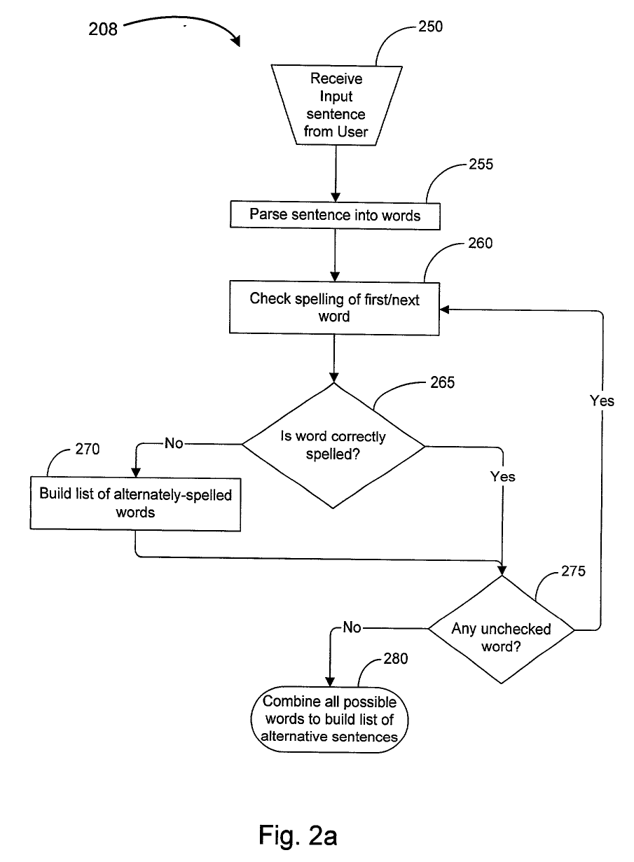

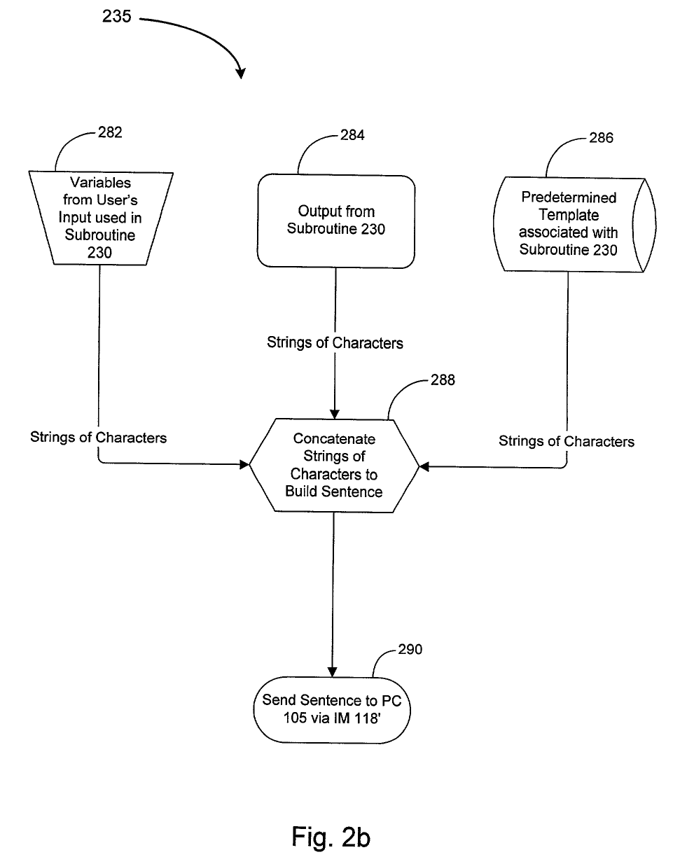

With reference now to FIG. 2, an interface 200 of chat-bot 125 (FIG. 1) receives an input. This input comprises a screen-name and a sentence. This sentence or set of words represents a query or command that is to be executed, or it can also be just a piece of casual conversation.

Interface 200 is connected to a first subroutine 202. Subroutine 202 checks the screen-name with a list of screen-names of known users. A test box, or decision box 204 performs a test on the first word of the message which is the user's screen-name, and compares this first word with screen-names contained in database 130, which contains a list of screen-names of known users.

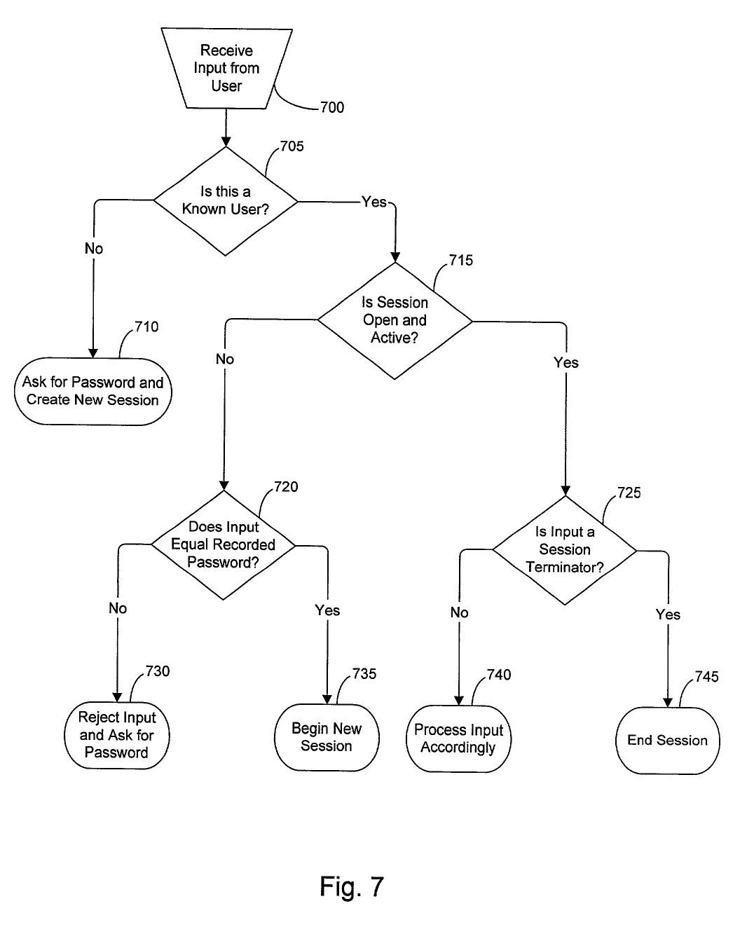

Chat-bot 125 is presently set up as a free service open to any new user who chooses a unique screen-name. Alternatively, if a member-only program is desired, a conventional identification subroutine could be used to confirm the identity of the user, as described hereinbelow with reference to FIG. 7.

If the screen-name of user 100 does not match any screen-name in the list of known users, i.e. if user 100 is a new user, then chat-bot 125 sends a command 206 to database 130, shown in FIG. 1, that creates a new entry 140 in database 130 for the new user 100, named after the screen-name of the new user 100. The program then branches to a subroutine 208.

If the screen-name of user 100 matches a screen-name in the list of known users then the program branches directly from decision box 204 to subroutine 208.

Subroutine 208 spell-checks the input sentence. If the input sentence is incorrectly spelled, subroutine 208 builds a set of alternative, correctly spelled input sentences, as described in more detail hereinbelow and illustrated in FIG. 2a. If the input sentence is correctly spelled it is just kept as it is.

Subroutine 208 is connected to a subroutine 210 which compares the input sentence sent by user 100 and every alternative input sentence built by subroutine 208 to a template read from a list of predetermined templates stored for example on the hard-disk of remote computer 120, FIG. 1, and examples of which are listed in Appendix A and Appendix B.

A test 215 tests whether the input sentence or a part of it matches the template. If the input sentence (or a part of it) does not match the template, then a test 220 checks whether there remains any unchecked templates in the list of predetermined templates. If test 220 finds unchecked templates, the program loops to subroutine 210 where the input sentence and alternatives are compared to another template in the list, followed by test 215.

A loop comprising subroutine 210, test 215 and test 220 is repeated until test 215 yields a positive result, i.e. the input sentence matches a predetermined template, or until test 220 yields a negative result, i.e. no unchecked templates are left in the list of predetermined templates. In one embodiment, the reading and comparing of templates can be linear, in the order stored. In other embodiments, this can be more directed as determined by the nature of the input sentence.

If no unchecked templates are left in the list of predetermined templates and no match has yet been found between the input and any predetermined template, then chat-bot 125 exits the loop, and a command 225 sends a generic message to user 100 such as “I don't understand what you're telling me”, or a piece of casual conversation related to the input sentence.

If test 215 finds a predetermined template that matches the input sentence (or a part of it), then a process 228 identifies as variables one or more strings of characters located in a part of the input sentence corresponding to a variable part of the template, and a command 230 is executed. Command 230 uses these variables to call a subroutine associated with the predetermined template. An output generated by the subroutine is then sent by a command 235 to personal computer 105 of user 100, via IM 118′.

With reference now to FIG. 2a, there is depicted a schematic flow diagram illustrating in detail how subroutine 208, shown on FIG. 2, spell-checks an input sentence and builds alternative input sentences based on alternative spellings of incorrectly spelled words found in an input sentence. The input sentence is received at interface 250.

Interface 250 is connected to a function 255 which parses the input sentence into separate words. Each word is successively spell-checked by a function 260 which compares the word to words stored in a dictionary which is in turn stored on the hard-disk of remote computer 120 or in local database 130, shown in FIG. 1.

Function 260 is connected to a test 265, which branches to a process box 270 if the test yields a positive result, or to a further test 275 if the result is negative. Test 265 tests whether the word compared by function 260 to words in the dictionary is correctly spelled or not. If the word is not correctly spelled, then process 270 builds a list of alternative, correctly spelled words having a very close spelling, that represent the possible intended meaning of the input sent by user 100. For example, if the string of characters “hlp” is found in the input, process 270 builds a list of alternative words that comprises the word “help”.

Test 275 then checks whether there is any word left unchecked in the input sentence or not. If test 275 yields a positive answer, the program branches back to function 260 and reiterates the actions and checks described hereinabove. When test 275 yields a negative answer, i.e. when all words have been checked in the input sentence, then the program branches to function 280, which combines all possible words, correctly spelled, misspelled and alternately-spelled words to build a list of alternative input sentences that are used by subroutine 210 as shown on FIG. 2.

With reference now to FIG. 2b, there is depicted a schematic flow diagram illustrating in detail how subroutine 235, shown on FIG. 2, builds a response sentence based on an output from subroutine 230, shown on FIG. 2, and sends it back to personal computer 105 of user 100.

A set of variables 282, used as input in subroutine 230, is combined with an output 284 from subroutine 230 and with a predetermined template 286 associated with subroutine 230. Set of variables 282, output 284 and predetermined template 286 are represented by strings of characters. These strings of characters are concatenated by a process 288 which builds a natural language sentence that is sent by command 290 back to personal computer 105 of user 100, via IM 118′.

Predetermined template 286 is selected by chat-bot 125 from a list of predetermined templates stored for example on the hard-disk of remote computer 120, FIG. 1. Appendix B attached hereinbelow contains a non-limiting example set of predetermined “Insertion” templates. These “Insertion” templates are used in process 288 for inserting variables 282 and output 284 in them and thereby building a natural language sentence. For example, if chat-bot 125 receives a request of a type such as:

“What is the distance between <CITY 1> and <CITY 2?”

and subroutine 230 determines that the answer to this request is <DISTANCE>, then an associated predetermined template such as:

“The distance between <CITY 1> and <CITY 2> is <DISTANCE> km”

is selected to build a natural language response where <CITY 1> and <CITY 2> are substituted with the actual strings of characters identified as variables in the request received by chat-bot 125, and <DISTANCE> is substituted with the actual output of subroutine 230.

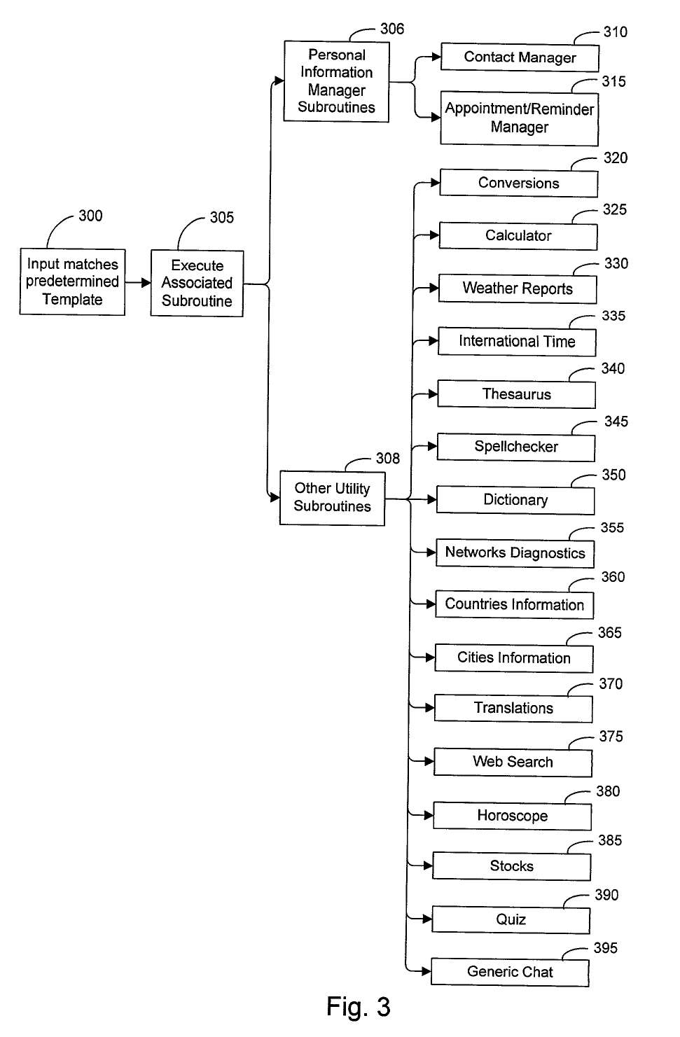

With reference now to FIG. 3, there is depicted a schematic flow diagram representing an example of a set of functions and/or modules that are made available through chat-bot 125 according to the present invention.

At a step 300 in the program, a match is found between the input sent by user 100 via IM 118 and a predetermined template. Step 300 connects to a command 305 which calls a subroutine associated with the matching predetermined template. Command 305 branches to two sets of functions and modules: a first set 306 that contains Personal Information Manager subroutines and a second set 308 that contains a wide variety of other utility subroutines. Boxes 310 and 315 represent modules of the Personal Information Manager, and boxes 320-395 on FIG. 3 represent examples of other utility functions and modules also associated with predetermined templates in a presently preferred embodiment of the invention.

In use a Contact Manager 310 allows user 100 to store, manage and retrieve information about personal contacts, i.e. about persons known by user 100. Such information comprises, without limitations, the person's name, one or more addresses, several types of telephone numbers (home, work, cellular, facsimile, pager), the person's e-mail address, a personal or professional web site URL, one or more Instant Messaging screen-names, the person's professional title, a name of employer or company.

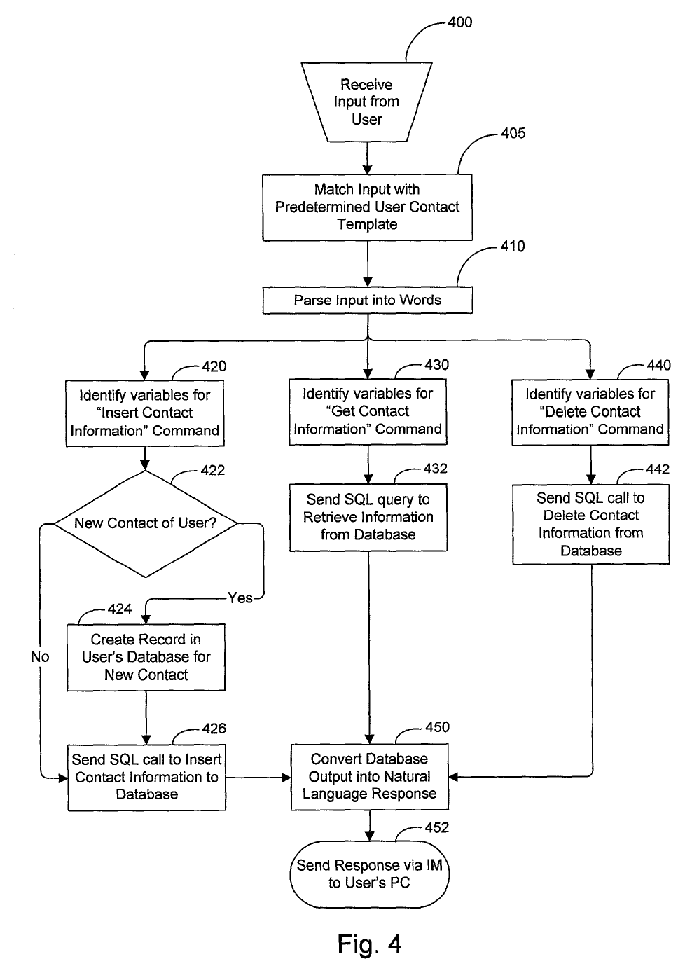

Appendix A incorporated herein shows an example of a list of predetermined templates associated with Contact Manager 310 functions. This list is stored for example on the hard-disk of remote computer 120, and is read by chat-bot 125 to associate a message sent by user 100 with a command executable by Contact Manager 310, as described in FIG. 1. A more detailed description of Contact Manager 310 is given hereinbelow with reference to FIG. 4.

In use an Appointment/Reminder Manager 315 allows user 100 to record, delete or retrieve personal appointments, and to set, check or delete reminders. Reminders trigger a delayed command in remote computer 120, shown in FIG. 1, that sends a message back to user 100 via IM 118′ at a pre-set time.

User 100 enters future appointments by sending to chat-bot 125 a message of a type such as:

“I am meeting with <NAME> <TIME/DATE>”, or

“I have a <TYPE> appointment on <TIME/DATE>”.

User 100 can also ask chat-bot 125:

“What are <TIME/DATE> appointments?”, or

“Who am I meeting for <TYPE>?”

where <NAME>, <TIME/DATE> and <TYPE> represent strings of characters associated with variables of type, respectively NAME of person to meet, TIME and/or DATE of appointment, and TYPE of appointment.

Hereafter are examples of actual messages sent by user 100 to chat-bot 125 when using the invention:

“What are Monday's appointments?”, or

“Who am I meeting for lunch?”

Appointment/Reminder Manager 315 also sends timely reminders to user 100 about meetings and appointments stored as appointments in the PIM, or just about anything that has to be done or remembered without being necessarily associated with a stored appointment. To set a reminder user 100 just needs to send a message to chat-bot 125 such as:

“Remind me <TIME/DATE> that I have a <TYPE> with <NAME> <TIME/DATE>”, or

“Remind me <TIME/DATE> <TO DO THING>”.

For example:

“Remind me tomorrow at noon that I have a dinner appointment with Sally at 6:00 pm”, or

“Remind me at 5:00 pm to buy milk”.

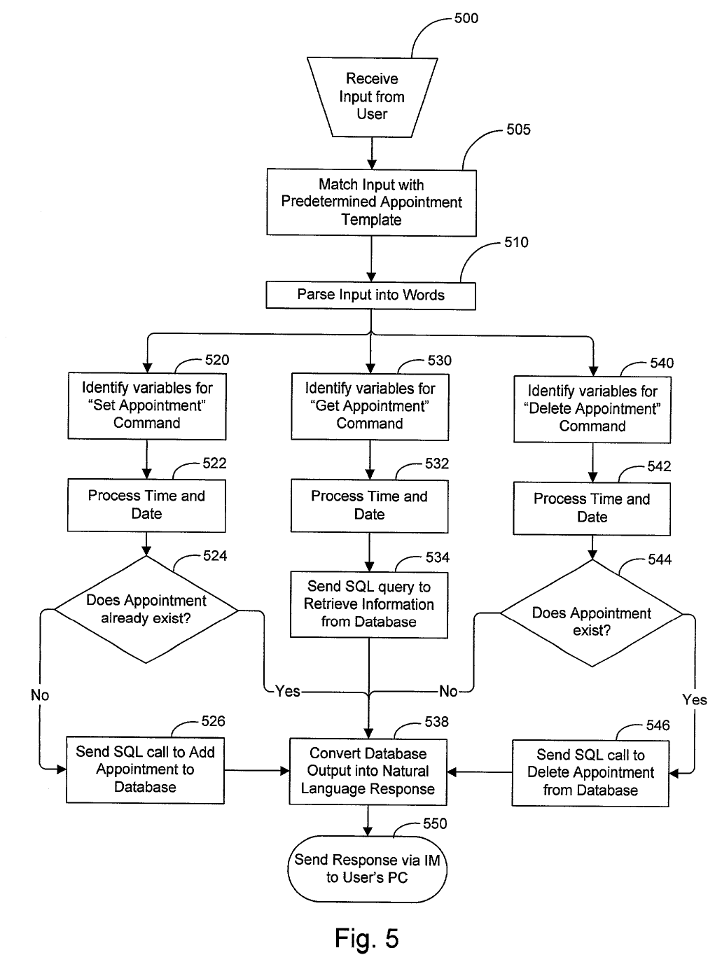

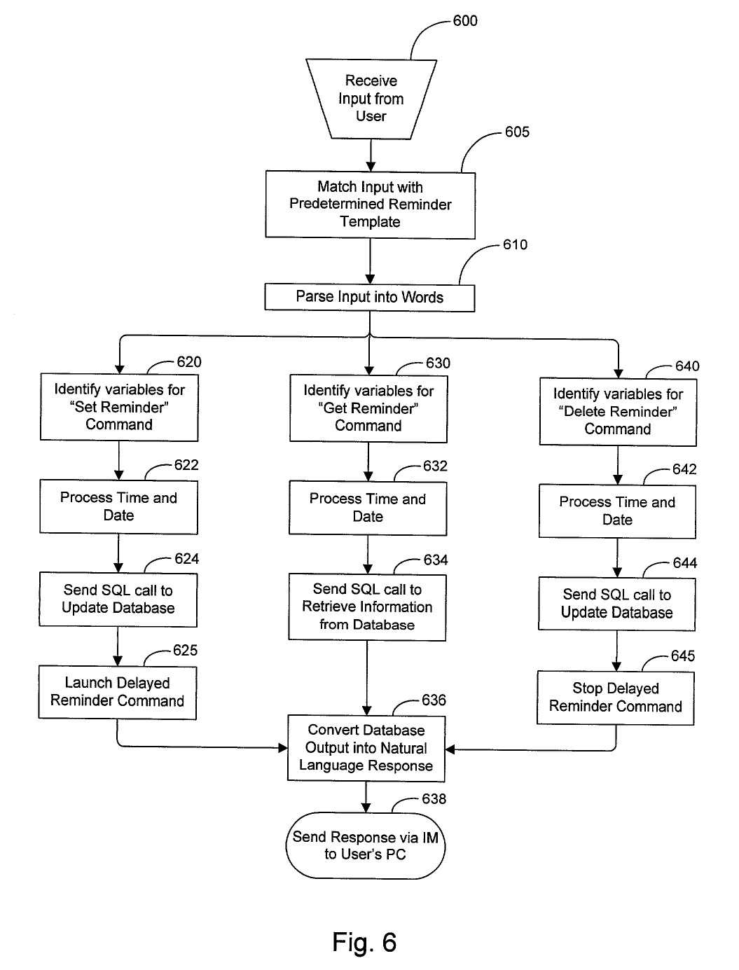

In the first example hereinabove, “Remind me” is recognized by chat-bot 125 as an Appointment/Reminder Manager template, and “tomorrow at noon” is then recognized as a TIME/DATE variable; “dinner appointment” as a TYPE variable; “Sally” as a NAME variable; and “6:00 pm” as a TIME/DATE variable. A command associated with the template “remind me” and using variables “tomorrow at noon”, “dinner appointment”, “Sally” and “6:00 pm” is sent by Appointment/Reminder Manager 315 to update a portion 140 of database 130, corresponding to user 100. A more detailed description of Appointment/Reminder Manager 315 is given hereinbelow with reference to FIG. 5 and FIG. 6.

A Conversions module 320 performs conversions between measurement units and also does currency conversions. Conversions module 320 answers questions of a type such as:

“How many <UNIT1> are in <UNIT2>?”, or

“How many <UNIT1> are in <QUANTITY> <UNIT2>?”

where UNIT1 and UNIT2 are measurement or currency units and QUANTITY is a numerical variable.

Hereafter are examples of actual questions answered by Conversion module 320:

“How many teaspoons are in a cup?”, or

“How many feet are in 17 miles?”

Conversions module 320 converts between different units, and also converts currencies. For example, it can convert Mexican Pesos into Japanese Yens, or European Euros into United States Dollars. Conversions module 320 can also tell, for example, what the roman numeral for number 1962 is and also, in yet another example, convert “4F” from an hexadecimal computer representation to base 10 representation.

A Calculator module 325 performs all kinds of operations that a conventional electronic calculator does. Calculator module 325 evaluates the result of any simple mathematical calculation submitted by user 100 such as, for example:

“What is <NUMBER1> <OPERATOR> <NUMBER2>”, or

“(<NUMBER1> <OPERATOR> <NUMBER2>) <OPERATOR> (<NUMBER3> <OPERATOR> <NUMBER4>)”,

where NUMBER1, NUMBER2, NUMBER3 and NUMBER4 represent numerical variables and OPERATOR represents a mathematical operator.

Hereafter are examples of messages sent by user 100:

“What is 5 times 5.4?”, or

“(3+3)/(4*3)”

Calculator module 325 converts the message into a regular mathematical expression, calculates the result of the expression and then inserts the result of the calculation into a natural language sentence that is sent back to user 100 through IM 118′.

A Weather Reports module 330 provides weather forecast for any location in the United States of America. Weather Reports module 330 can also be modified on demand to query remote web sites that provide current weather information or weather forecast for other parts of the world. User 100 can get the current weather or weather forecast for any city by asking chat-bot 125 a question such as, for example:

“What is the weather in Fremont, Calif.”, or

“How will the weather be tomorrow night in Chicago, Ill.?”, or simply

“Weather San Francisco, Calif.”, or

“Forecast Las Vegas, Nev.”.

User 100 can also ask for a local weather forecast by sending chatbot 125 a location with a message such as, for example:

“I am in Fremont, Calif.”, and

then just sending a message such as, for example:

“weather?”

to chat-bot 125. In this example the location “Fremont, Calif.” is stored in portion 140 of database 130 associated to user 100. Any subsequent query by user 100 to get a local weather forecast will use that location, until a new command such as, for example:

“I now live in San Francisco, Calif.”

is sent by user 100 to update the local location stored in user 100's portion 140 of database 130.

An International Time module 335 provides the current date and time for any location in the world. User 100 can ask chat-bot 125 what time it is in most major cities and in all countries around the world. International Time module 335 also calculates what time it is in a first given place when it is a certain time in a second given place by asking:

“What time is it in Paris, France?”, or

“If it's 10:00 AM in New York, N.Y. what time is it in San Francisco, Calif.?”

User 100 can also get the local time by sending a location in a first message to chat-bot 125, such as:

“I am in San Francisco, Calif.”

and then simply asking for the time in a following message such as, for example:

“What time is it”, or just “Time”.

A Thesaurus module 340 provides synonyms for any word existing in a dictionary; a Spellchecker module 345 allows user 100 to check the spelling of a word and provides the correct spelling or alternative words; and a Dictionary module 350 allows user 100 to check the meaning of a word. User 100 can get synonyms, a correct spelling, and definition of any word by asking chat-bot 125 a question of a type such as

“Define <WORD>”, or

“How do you spell <WORD>?”, or

“What does <WORD> mean?”, or

“Thesaurus <WORD>”

where WORD represent any word, i.e. any string of characters. For example, user 100 can send chat-bot 125 a message such as:

“Define jump”, or

“How do you spell jump?”, or

“What does jump mean?”, or

“Thesaurus jump”

In these examples, the word “jump” is identified by Thesaurus module 340, or Spellchecker module 345, or Dictionary 350 as the word to be search for in local database 130. The result from the search is then assembled in a natural language sentence by chat-bot 125 and sent back via IM 118′ to personal computer 105 of user 100.

A Networks Diagnostics module 355 provides means to check the status of a computer network, or part of it, using conventional Unix commands. Chat-bot 125 performs “whois”, “traceroute” and “ping” lookups. Chat-bot 125 interprets messages sent by user 100 of a type such as:

“whois <DOMAIN>”, or

“traceroute <DOMAIN>”or

“ping <DOMAIN>”.

For example, chat-bot 125 interprets messages such as:

“whois he.net”, or

“traceroute he.net”, or

“ping he.net”,

and then actually sends the corresponding Unix commands to get network status information. An output from these lookups is sent back, as they are, to user computer 105 via IM 118′.

A Countries Information module 360 provides geographic and demographic information about any country in the world. Countries Information module 360 provides access to a map of the country and a national flag, and sends user 100 the birth rate, death rate, information about climate, government type, GDP and any other type of information accessible through the Internet. Chat-bot 125 also interprets and answers questions of a type such as:

“What is the population of <COUNTRY>?”, or

“What is the birth rate of <COUNTRY>?”

“Show me a map of <COUNTRY>”, or

“Show me the flag of <COUNTRY>”

where <COUNTRY> represents a string of characters that chat-bot 125 interprets as a variable of type COUNTRY. For example, chat-bot 125 interprets messages such as:

“What is the population of Canada?”, or

“What is the birth rate of Canada?”, or

“Show me a map of France”, or

“Show me the flag of France”,

and Countries Information module 360 then retrieves the corresponding information from publicly available web sites such as the CIA World Fact-Book web site. The relevant information retrieved from this web site is then sent via IM 118′ to personal computer 105. When the query is for an image (such as a map or a flag) the response sent to personal computer 105 is a clickable hyperlink, which when clicked on with a pointer device, such as a mouse, opens a browser window on monitor 113 and displays the requested image retrieved from the web site. When the query is for a piece of information that can be represented by a string of characters, the response sent to personal computer 105 is a sentence containing the answer to the question, such as for example the birth rate or the population of a country.

A Cities Information module 365 provides geographic and demographic information about every city in the United States of America. Cities Information module 365 answers questions about the location of a city, where a zip code is, what the zip code for a city is, the distance between two cities, the population, and what area codes are in a particular city, for example. Chat-bot 125 interprets and answers questions of a type such as:

“Where is <CITY>, <STATE>?”, or

“Where is <ZIPCODE>?”, or

“What is the distance between <CITY A> and <CITY B>”, or

“What is the zip code for <CITY>, <STATE>?”, or

“What cities are in <COUNTY> county, <STATE>?”, or

“What is the population of <CITY>, <STATE>?”, or

“What area code is <CITY>, <STATE>?”

where <CITY>, <CITY A>, <CITY B>, <STATE> and <ZIPCODE> represent strings of characters that chat-bot 125 interprets as variables, i.e. arguments to be used in a database query sent to database 130. The result of the database query is then sent back via IM 118′ to personal computer 105.

A Translations module 370 provides translations of words and sentences between several languages. Chat-bot 125 interprets and answers questions of a type such as:

“Translate <WORDS TO TRANSLATE> into <LANGUAGE>”, or

“Translate <WORDS TO TRANSLATE> from <LANGUAGE1> into <LANGUAGE2>”

For example, chat-bot 125 interprets messages such as:

“Translate Hi, my name is MyOwnBuddy into Spanish”, or

“Translate Comment allez vous? from French into English”

to build corresponding queries and send the corresponding queries to remote translations services publicly available on the Web. The result of the queries is then sent back via IM 118′ to personal computer 105.

A Web Search module 375 allows user 100 to send a web search query to a remote web search engine, and receive in return a list of most relevant web sites found by the remote web search engine. Chat-bot launches Web Search module 375 when it receives a message from personal computer 105 such as:

“Search <WHAT YOU ARE LOOKING FOR>”, or

“Search the web for <WHAT YOU ARE LOOKING FOR>”

where <WHAT YOU ARE LOOKING FOR> is a string of characters that Web Search Module 375 uses as argument of a query sent to the remote web search engine. For example, when chat-bot 125 receives a message such as:

“Search famous baroque painters”, or

“Search the web for The Beatles White Album”,

the message is interpreted as being a Web Search module 375 command and a query is sent to a remote web search engine with argument “famous baroque painter” (in the case of the first example) or “The Beatles White Album” (in the case of the second example) . The result of the query is then sent back via IM 118′ to personal computer 105.

A Horoscope module 380 provides astrological predictions and/or advice for entertainment purposes, based on a date of birth or an astrological sign. The predictions and or advice are retrieved from remote web sites, and sent back via IM 118′ to personal computer 105.

A Stocks module 385 provides stock quotes from stock markets in real time. Information on stock markets is retrieved from remote web sites, and sent back via IM 118′ to personal computer 105.

A Quiz module 390 allows user 100 to play trivia games with chat-bot 125. Chat-bot 125 identifies a sentence such as “new car trivia” as a command that triggers Quiz module 390. Quiz module 390 sends questions about a predetermined subject to personal computer 105 and then waits for an answer. The answer sent by user 100 is then parsed, and checked with a list of correct answers stored for example on the hard-disk of remote computer 120. The result is then sent back via IM 118′ to personal computer 105.

A Generic Chat module 395 generates natural language responses to messages that do not correspond to predetermined templates associated with a specific utility function or module. For example, in response to a message sent by user 100 such as “How are you?” chat-bot 125 assembles an answer such as “I'm fine, and you?” and this answer is sent back via IM 118′ to personal computer 105.

A Help module, not shown, provides general information and assistance about chat-bot 125 and also module-specific instructions on how to use each module. For example, chat-bot 125 interprets messages such as:

“Help”,

“Help contact”, or

“Help appointment”

as Help module requests, and sends back to personal computer 105 of user 100, via IM 118′, a set of appropriate predetermined instructions according to the received message.

With reference now to FIG. 4, there is depicted a schematic flow diagram representing the processes and information flow in a User Contact Manager module according to the present invention.

An input message is received via IM 118′ from personal computer 105 of user 100 at interface 400. Interface 400 is connected to a process box 405 that matches the input message with a predetermined user contact template as described in FIG. 2 and FIG. 2a, where a portion of the program performs spell-checking and template-matching operations.

The input is then parsed into words by process box 410 to identify the type and nature of the input message. Process box 410 branches into three types of action depending on the type of the input. The three types of action identifiable by process box 410 in a currently preferred embodiment of the invention are: inserting a contact information, getting a contact information and deleting a contact information.

A first type of action described in FIG. 4 is “inserting a contact information”. A process box 420 of the program identifies the variables that the User Contact Manager needs to insert the contact information.

A list of several predetermined templates is shown in Appendix A incorporated herein. These templates are examples of some of the templates that chat-bot 125 tries to match with a message, or part of a message, sent by user 100.

In these templates the words between the left bracket “<” and the right bracket “>” represent character string variables that are stored in, and retrieved from, database 130. The other words in the templates are associated with, and represent, types of data that the variables belong to.

For example, when user 100 sends the following message to chat-bot 125:

“John's mobile telephone number is 703-555-0666”,

chat-bot 125 identifies the phrase “mobile telephone number is” as a predetermined template. Chat-bot 125 then identifies “john” as a variable of type NAME and identifies “703-555-0666” as a variable of type CELLNUMBER. The predetermined template “mobile telephone number is”, identified by chat-bot 125, determines the type of action that has to be carried out. In this example, the action is to store “703-555-0666” as a CELLNUMBER variable in the separate portion 140 of database 130 corresponding to NAME “john”.

Process box 420 is connected to a decision box or test 422. Test 422 checks whether the message sent by user 100 is about a new contact or about a contact already present in a list of contacts of user 100 stored in database portion 140. If the contact is a new contact, command 424 is executed to create a new record in database portion 140 for said new contact. Command 426 is then executed to send a Structured Query Language (SQL) call which inserts the contact information in database 130. If the contact is already listed in database portion 140, then command 426 is immediately executed to insert the contact information in database 130.

In both cases, i.e. new contact or already listed contact, the program branches to a process box 450, which converts an output from database 130 into a natural language sentence. This natural language sentence is then sent by command 452 as a response back to personal computer 105 of user 100, via IM 118′.

A second type of action described in FIG. 4 is “getting a contact information”. A process box 430 of the program identifies the variables that the User Contact Manager uses to get a contact information appointment. For example, in an input message such as:

“What do you know about John?”

process 430 identifies “John” as a user contact first name. This first name is then used in an SQL call sent by process 432 to database 130 to retrieve all the information available about “John”.

As in the case of a “inserting a contact information” command, the output returned by database 130 for a “getting a contact information” command is converted into a natural language sentence by process 450 and sent back by command 452 to personal computer 105 of user 100, via IM 118′.

A third type of action described in FIG. 4 is “deleting a contact information”. A process box 440 of the program identifies the variables that the User Contact Manager uses to delete a contact information appointment. For example, in an input message such as:

“Delete John's address”

process 440 identifies “John” as a user contact first name. This first name is then used in an SQL call sent by process 442 to database 130 to delete the address information available about “John”.

As in the case of a “inserting a contact information” command or a “getting a contact information” command, the output returned by database 130 for a “deleting a contact information” command is converted into a natural language sentence by process 450 and sent back by command 452 to personal computer 105 of user 100, via IM 118′.

With reference now to FIG. 5, there is depicted a schematic flow diagram representing the processes and information flow in an Appointment Manager module according to the present invention.

An input message is received via IM 118′ from personal computer 105 of user 100 at interface 500. Interface 500 is connected to a process box 505 that matches the input message with a predetermined appointment template as described in FIG. 2 and FIG. 2a, where a portion of the program performs spell-checking and template-matching operations.

The input is then parsed into words by process box 510 to identify the type and nature of the input message. Process box 510 branches into three types of action depending on the type of the input. The three types of action identifiable by process box 510 in a currently preferred embodiment of the invention are: setting an appointment, getting an appointment and deleting an appointment. In another embodiment of the invention, other actions could be added to the program such as, for example: modifying an appointment, make an appointment a daily, or weekly, or monthly appointment.

A first type of action described in FIG. 5 is “setting an appointment”. A process box 520 of the program identifies the variables that the Appointment Manager needs to set the appointment. These variables are: a date, a time, a person to meet, a kind of appointment and an adjective that qualifies the person to be met. For example, an input message such as:

“I am meeting my wife tomorrow at noon for a fundraiser lunch”

is parsed into words by process box 510, and process box 520 then identifies “tomorrow” as a date; “at noon” as a time; “wife” as the person to meet; “a fundraiser lunch” as a kind of appointment and “my” as an adjective that qualifies “wife”.

Date and time can be given as relative quantities, for example: “tomorrow at noon”, or “in two hours”; or as absolute quantities, for example: “on Feb. 28, 2002, at 12:00 pm”. Process 522 converts date and time, as identified in the input by process 520, into an absolute date and time and then into a machine readable format that are used to build an SQL query sent to database 130.

The date and time in machine readable format are used in decision box 524 to check whether an appointment with an identical date and time, an identical person to meet and an identical nature of the appointment is already recorded in portion 140 of database 130.

If decision box 524 yields a positive answer, i.e. if an appointment with identical date, time, person to meet and nature of the appointment is already present in portion 140 of database 130, then the program branches directly to a process box 538, which converts an output from database 130 into a natural language sentence. This natural language sentence is then sent by command 550 as a response back to personal computer 105 of user 100, via IM 118′.

If decision box 524 yields a negative answer, i.e. if no appointment with an identical date and time is present in portion 140 of database 130, then the program branches to process box 526, where an SQL call is assembled with the identified variables and sent to database 130 to add a new appointment. Process box 526 is again connected to process box 538, which in turn feeds into command box 550. Command 550 sends a natural language sentence representing the output of database 130 converted by process 538, to personal computer 105 of user 100, via IM 118′.

A second type of action described in FIG. 5 is “getting an appointment”. A process box 530 of the program identifies the variables that the Appointment Manager uses to get an appointment. These variables include: a date, a time, a person to meet, a kind of appointment and an adjective that qualifies the person to be met. For example, in an input message such as:

“What appointments do I have tomorrow”

process 530 identifies “tomorrow” as a relative date that is then processed by process 532 to convert it into a machine readable absolute date. This absolute date is then used in an SQL call sent by process 534 to database 130 to retrieve all appointments corresponding to the converted absolute date.

Process 530 can also identify a range of dates and/or times represented by variables such as, for example:

“next week”, “this week”, or “on Monday”.

As in the case of a “setting an appointment” command, the output returned by database 130 for a “getting an appointment” command is converted into a natural language sentence by process 538 and sent back by command 550 to personal computer 105 of user 100, via IM 118′.

A third type of action described in FIG. 5 is “deleting an appointment”. A process box 540 of the program identifies the variables that the Appointment Manager uses to delete an appointment. These variables include: a date, a time, a person to meet, a kind of appointment and an adjective that qualifies the person to be met. For example, in an input message such as:

“Delete all the appointments I have tomorrow”

process 540 identifies “tomorrow” as a relative date that is then processed by process 542 to convert it into a machine readable absolute date. The absolute date in machine readable format is used in decision box 544 to check whether any appointment with an identical date is recorded in portion 140 of database 130.

If decision box 544 yields a negative answer, i.e. if no appointment with an identical date is present in portion 140 of database 130, then the program branches directly to process box 538, which converts an output from database 130 into a natural language sentence. This natural language sentence is then sent by command 550 as a response back to personal computer 105 of user 100, via IM 118′.

If decision box 544 yields a positive answer, i.e. if an appointment with an identical date is present in portion 140 of database 130, then the program branches to process box 546, where this absolute date is used in an SQL call sent by process 546 to database 130 to delete all appointments corresponding to the converted absolute date.

As in the case of a “setting an appointment” command or a “getting an appointment” command, the output returned by database 130 for a “deleting an appointment” command is converted into a natural language sentence by process 538 and sent back by command 550 to personal computer 105 of user 100, via IM 118′.

With reference now to FIG. 6, there is depicted a schematic flow diagram representing the processes and information flow in a Reminder Manager module according to the present invention.

The Reminder Manager module performs all the functions performed by the Appointment Manager module and additionally it identifies two more variables that are used to determined a date and a time at which a reminder must be sent to user 100. The Reminder Manager module also uses a conventional Unix command called “at” to schedule the sending of reminder messages via IM 118′. However, any other appropriate task scheduler can be used to perform the scheduled sending of reminder messages.

As in the case of the Appointment manager, an input message is received at an interface 600, which is connected to a template-matching process 605, which in turn is connected to a word-parsing process 610. Process 610 branches into three types of actions similar to the three types of action described for the Appointment manager module. In the case of the Reminder Manager module according to a currently preferred embodiment of the invention, the three types of action, as shown in FIG. 6 are: setting a reminder, getting a reminder and deleting a reminder. Other types of action can be added on command such as, for example: modifying a reminder, setting a recurrent or periodic reminder.

Process boxes 620-624 describe how the variables for a “Set Reminder” command are identified, and the date and time variables are converted into a machine readable format that is used to send an SQL call to update database 130. Process 625 then launches the delayed sending of a reminder message, using the Unix “at” command, and process 636 converts an output from database 130 into a natural language message that is sent by command 638 back to personal computer 105 of user 100, via IM 118′.

A “Delete Reminder” command follows a process flow, as show by items 640-645 on FIG. 6, similar to the above described process flow of the “Set Reminder” command, with the difference that the SQL call to database 130 deletes a reminder instead of creating the reminder, and that the call to the Unix “at” command stops the delayed sending of the reminder instead of launching it. The conversion of the output from database 130 by process 636 and the sending of a message by command 638 are then performed by a procedure identical to the procedure used for the “Set Reminder” command.

A “Get Reminder” command follows a process flow, as show by items 630-634 on FIG. 6, similar to the above described process flow of the “Set Reminder” command and the “Delete Reminder” command, with the difference that the SQL call to database 130 retrieves a reminder instead of creating or deleting the reminder, and no call is made to the Unix “at” command. The conversion of the output from database 130 by process 636 and the sending of a message by command 638 are then performed by a procedure identical to the procedure used for the “Set Reminder” command and the “Delete Reminder” command.

With reference now to FIG. 7, there is depicted a schematic flow diagram representing the processes and information flow of a Security Control manager according to the present invention. The Security Control manager is a feature that ensures the privacy of personal information stored on database 130. This privacy is achieved by a combination of a screen-name and an associated password that are requested to access database 130.

An input from personal computer 105 of user 100, as shown in FIG. 1, is received at interface 700 via IM 118′. Interface 700 is connected to a decision box 705. Decision box 705 tests whether a first word of the input, which represents the screen-name of user 100, matches a screen-name in a list of known users stored for example in database 130.

If decision box 705 yields a negative answer, i.e. if the screen-name of user 100 is not in the list of known users, then the program branches to process box 710 where chat-bot 125 sends a message to user 100 via IM 118′ asking for a new password, and creates a new session.

If decision box 705 yields a positive answer, i.e. if user 100 is a known user, then the program branches to a decision box 715. Decision box 715 tests whether an IM session is open between personal computer 105 and remote computer 120, and checks whether the session has been active within a period of time no longer than a predetermined timeout limit. This timeout limit can be set for example to fifteen minutes, i.e. the session become inactive if no message is received from user 100 for more than fifteen minutes.

If decision box 715 yields a negative answer, i.e. if the session is inactive, then the program branches to decision box 720. If decision box 715 yields a positive answer, i.e. if the session is open and active, then the program branches to decision box 725.

Decision box 720 tests whether the input matches a password previously sent by user 100 and stored for example in database 130. If the input does not match the password, then a command 730 sends a message via IM 118′ back to personal computer 105 of user 100, that rejects the input and asks again for a password. If the input matches the password associated with user 100, then command 735 opens a new session and sets the session to an active state.

Decision box 725 tests whether the input is a “session terminator”. A session terminator is a word or set of words which is set to mean that user 100 wishes to close the session. Chat-bot 125 can be set to identify words such as, for example: “bye”, “quit”, “exit”, “logout”, or “end”, as session terminators.

If decision box 725 yields a negative answer, i.e. if the input is not a session terminator, then the program branches to command 740 and the input is processed according to the procedures described hereinabove in FIGS. 2-6.

If decision box 725 yields a positive answer, i.e. if the input is a session terminator, then the program branches to command 745 which ends the session.

In use, user 100 can store, modify, delete and receive contact information, appointment and reminders stored in remote computer 120 and/or database 130 by sending and receiving messages to and from chat-bot 125 through IM 118, running on personal computer 105, and through IM 118′, running on remote computer 120. An example of a typical session of communication between user 100 and chat-bot 125 is shown in Appendix C incorporated hereinbelow, where user 100's input lines start with a leading screen-name “exampleuser100” and chat-bot 125's responses start with a leading screen-name “MyOwnBuddy”.

In a currently preferred embodiment of the present invention, IM 118 and IM 118′ are an instant messaging application freely provided by America Online and called “AOL Instant Messenger” or simply “AIM”. Chat-bot 125 is recognized by AIM as just a normal subscriber of AIM, and the screen-name currently used by chat-bot 125 on AIM is “MyOwnBuddy” (as already mentioned above). However, chat-bot 125 can easily be adapted to be used through any other Instant Messaging service and any screen-name can be set to represent chat-bot 125 on said Instant Messaging service. Other examples of Instant Messaging services currently available include “ICQ” (also provided by America Online), “MSN Messenger” (provided by Microsoft Corporation), and “Yahoo! Messenger” (provided by Yahoo! Inc.).

In the currently preferred embodiment of the present invention, chat-bot 125 and all subroutines and modules called by chat-bot 125 are written in a scripting computer language such as Perl (Practical Extraction and Report Language). However any other language with comparable regular expression handling capabilities could be used to write the source code of chat-bot 125 and the subroutines and modules called by chat-bot 125.

In the currently preferred embodiment of the present invention, local database 130 is built and managed by a database management system called MySQL which is an open source database management system. However, any other database management system with comparable database management capabilities could be used to build and manage local database 130.

Although only a few exemplary embodiments of the present invention have been described above, it will be appreciated by those skilled in the art that many changes may be made to these embodiments without departing from the principles and the spirit of the invention.

[image]

[image]

[image]

[image]

[image]

[image]

What is claimed is:

1. A personal information management system for remote storage, management and retrieval of personal information comprising, in combination:
a computer apparatus connected to a communications network;
a chat-bot software application (chat-bot) operational with said computer apparatus;
a database stored on a computer storage medium connected to said computer apparatus and directly accessible to said chat-bot;
a “Contacts Manager” module operational with said computer apparatus and directly accessible to said chat-bot for storage, management and retrieval of personal contacts information stored on said database; and
an instant messaging agent using said communications network, said instant messaging agent allowing a user to communicate with said chat-bot and interact with said chat-bot in a way identical to the way the user would interact with a human person using the instant messaging agent.

2. A personal information management system as claimed in claim 1 wherein said computer apparatus is a conventional personal computer.

3. A personal information management system as claimed in claim 1 wherein said computer apparatus is a conventional Unix workstation.

4. A personal information management system as claimed in claim 1 wherein said computer apparatus is a conventional mainframe computer.

5. A personal information management system as claimed in claim 1 wherein said chat-bot receives and sends natural language text messages through said instant messaging agent.

6. A personal information management system as claimed in claim 5 wherein said chat-bot parses said natural language text messages and converts them into structured query language calls to be sent to the database.

7. A personal information management system as claimed in claim 6 wherein said chat-bot builds natural language text responses back to the user through the communications network.

8. A personal information management system as claimed in claim 7 wherein said chat-bot comprises an “Appointment Manager” module adapted for storage, management and retrieval of personal appointments information stored on said database.

9. A personal information management system as claimed in claim 8 wherein said chat-bot further comprises a “Reminder Manager” module adapted for storage, management and retrieval of personal reminders information stored on said database.

10. A personal information management system as claimed in claim 9 wherein said chat-bot further comprises a set of utility modules for retrieval of publicly available information remotely accessible through the communications network.

11. A personal information management system as claimed in claim 10 wherein said set of utility modules comprises a “Weather Reports” module which searches a weather database that is accessible through the communications network and a “Web Search” module which performs a word-based search in a world wide web of computers connected to the communications network.

12. A personal information management system as claimed in claim 10 wherein said set of utility modules comprises a “Countries Information” module which searches a web site containing demographic, geographic, cultural and political information about a set of countries and a “cities Information” module which searches a database containing demographic, geographic and postal information about a set of cities.

13. A personal information management system for remote storage, management and retrieval of personal information comprising, in combination:
a communications network;
a computer server apparatus connected to the communications network;
a computer readable database connected to the computer apparatus;
a personal electronic communications device connected to the communications network;
a database management system accessible to said computer server apparatus;
a first instant messaging software application (IM1) stored in the computer server apparatus and executable by said computer server apparatus;
a second instant messaging software application (IM2) stored in the personal electronic communications device and executable by said personal electronic communications device; and
a chat-bot software application which receives and sends natural language text messages through IM1, said chat-bot software application being stored in the computer server apparatus and executable by said computer server apparatus, said chat-bot software application comprised of a module which parses said natural language text messages and converts them into structured query language calls useable with the database management system, and a module which builds natural language text responses and sends said natural language text responses back to the personal electronic communications device through IM1; and
wherein said personal electronic communications device communicates with said server computer apparatus over a link established between IM1 and IM2 through the communications network.

14. A personal information management system as claimed in claim 13 wherein said chat-bot software application is further comprised of a module which identifies a first word in a message received from said personal communication device with a user's screen-name and compares said user's screen-name with a list of screen-names of known users directly accessible to said computer server apparatus.

15. A personal information management system as claimed in claim 14 wherein said chat-bot software application is further comprised of a module which spell-checks an input sentence received from said personal communication device and builds a list of alternative input sentences.

16. A personal information management system as claimed in claim 15 wherein said chat-bot software application is further comprised of a module which checks said list of alternative input sentences against a list of predetermined templates and identifies a matching predetermined template and a type of query associated with said matching predetermined template.

17. A personal information management system as claimed in claim 16 wherein said chat-bot software application is further comprised of a module which identifies variables in the input sentence.

18. A personal information management system as claimed in claim 17 wherein said chat-bot software application is further comprised of a module which uses said variables and an identified type of query to build a formal database query that is sent to the database management system.

19. A method for storing, managing and retrieving personal information using a remote database connected to a network of computers and accessible through an instant messaging agent wherein a user provides and retrieves personal information from the remote database by sending natural language statements and queries through said instant messaging agent, said method comprising:
using a chat-bot software application for receiving, storing, managing and returning personal information to and from said user through said instant messaging agent;
using a communication link through said network using the instant messaging agent;
receiving a natural language message sent by the user through the instant messaging agent;
parsing the natural language message to identify the user and determine a type of message and corresponding input variables in the message;
constructing a formal database query according to the type of message and using the input variables;
sending the formal database query to the remote database;
receiving an output back from the remote database;
constructing a natural language sentence based on the type of message and using the output received from the database; and
sending the natural language sentence to the user through the network using the instant messaging agent.

20. A method of providing a remotely accessible personal information manager, said method combining the steps of:
running an instant messaging agent on a computer connected to a communications network and to a computer accessible database;
running a chat-bot software application (chat-bot), said chat-bot being able to use the instant messaging agent to send and receive messages from one or more user's computers connected to the network and running an instant messaging agent; said chat-bot being able to send queries to, and to retrieve information from the database; and said chat-bot being able to use an output from the database to build a natural language response and send it back to the user's computer through the instant messaging agent.

21. The method as claimed in claim 20 further comprising the step of receiving a natural language message through the instant messaging agent from one of a user's computer.

22. The method as claimed in claim 21 further comprising the step of identifying a first word in said natural language message with a user's screen-name and comparing said user's screen-name with a list of screen-names of known users directly accessible to the chat-bot, thereby determining whether the user is an already known user or a new user.

23. The method as claimed in claim 22 further comprising the step of creating a new entry in the database if the user is a new user.

24. The method as claimed in claim 23 further comprising the step of spell-checking a sentence or set of words contained in the message sent by the user and determining alternately-spelled words corresponding to words of the sentence that are misspelled.

25. The method as claimed in claim 24 further comprising the step of building a set of alternative sentences using combinations of alternately-spelled words.

26. The method as claimed in claim 25 further comprising the step of checking said set of alternative sentences against a list of predetermined templates and identifying a matching predetermined template and a type of query associated with said matching predetermined template.

27. The method as claimed in claim 26 further comprising the step of identifying variables in the sentence sent the user.

28. The method as claimed in claim 27 further comprising the step of using said variables and an identified type of query to build a formal database query and sending said formal database query to the database management system.

29. The method as claimed in claim 28 further comprising the step of combining an output from the database and an appropriate predetermined template to build a natural language response.

30. The method as claimed in claim 29 further comprising the step of sending said natural language response back to the user's computer through the instant messaging agent.

31. A method of maintaining a personal information manager, said method combining the steps of:
using a personal computer apparatus running an instant messaging agent and having access to a communications network to communicate with a remote computer apparatus running a chat-bot application and connected to a database;
sending a natural language sentence to said chat-bot through said instant messaging agent, said sentence containing a request message to said chat-bot to retrieve information from said database or providing information to said chat-bot for storing said information into said database;
receiving a natural language response from said chat-bot through said instant messaging agent, said response being a construction by said chat-bot of a natural language sentence built using information provided to said chat-bot in said request message, information provided by said database, and an appropriate predetermined template.
